(19) United States
(12) Patent Application Publication
(10) Pub. No.: US 2007/0164575 A1
(43) Pub. Date: Jul. 19, 2007

(54) Concrete lifting eye-recessed lifting box

(76) Inventor: Terry Allan Leach, Middleburg, FL (US)

Correspondence Address: Wilson Daniel Swayze, Jr., 3804 Clearwater Ct., Plano, TX, 75025, US

(21) Appl. No.: 11/332,458

(22) Filed: Jan. 13, 2006

(51) Int. Cl. B66C 1/00

(52) U.S. Cl. 294/1.1

(57) ABSTRACT

A lifting apparatus for lifting a load includes a sleeve for distributing a weight of said load and having a opening, a flexible wire rope to pass through the opening of said sleeve, a lifting box having an opening for accepting the sleeve and the flexible wire rope access to an interior of the lifting box and a breakable cover to provide access to the sleeve and flexible wire rope.

### FIELD OF THE INVENTION

The present invention relates to a load lifting apparatus which is suitable for use in material handling operations, for example carrying loads, which enables loads of various shapes and structures to be readily moved and to be easily released.

### BACKGROUND OF THE INVENTION

To lift and to move a heavy load for example a concrete block or pipe to a desired position are usually desired at a construction site, particularly a construction site of a road or large building. To lift and to move the heavy load, a wire rope or chain may be wound around the load, and the other end of the wire rope or chain may be engaged with a hook of the material-handling equipment. In this state, the load is lifted and moved to the desired position, and then, the wire rope or chain is removed from the load. Alternatively, some loads are lifted and moved to a desired position through the use of an engagement member such as a bolt or hook having been previously attached to the load. Under these circumstances, a wire rope or chain is attached to the engagement member and the other end of the wire rope or chain is attached to a hook of the material-handling equipment. The material-handling equipment may move the load to the desired location, and then after the load has been moved to the desired location, the wire rope is disengaged from the engagement member which has been attached to the load.

The material-handling equipment, for example a crane, may have a clamping apparatus for clamping to the load to be lifted. This clamping apparatus may be opened by human power or by using a jig for example a hydraulic device to pick up the load to be lifted.

One such clamping device is described in U.S. Pat. No. 6,286,881 where a load lifting apparatus is disclosed that is suitable for use in material-handling operations to enable loads of various shapes and structures for example concrete products to be clamped and released.

Another lifting apparatus is described in U.S. Pat. No. 3,300,062 that describes a lifting apparatus which is capable of lifting pre-cast concrete walls. This patent describes a lifting apparatus having a weight distributing or load spreading units in combination with a lifting unit.

A further lifting apparatus is described in U.S. Pat. No. 2,589,954 that describes a lifting apparatus for lifting and conveying or moving concrete wall slabs. This lifting apparatus allows a concrete wall slab to be raised from a flat or horizontal position to substantially upright position.

### SUMMARY OF THE INVENTION

It is an object of the invention to provide a lifting apparatus which is capable of efficiently raising extremely heavy objects such as walls, boxes, cylinders and pipes formed from concrete or a similar type of material.

It is an object of the present invention to provide a lifting apparatus which is of compact and lightweight construction and can be formed with concrete or the similar type material.

It is an object of the present invention to provide a lifting apparatus which is flexible and can be connected to a wire mesh or Rebar and formed with concrete or the similar material.

The present invention provides a lifting apparatus which significantly reduces the risk of breakage of the lifting apparatus below the level of the concrete and consequently reduces the risk that the object being lifted from being dropped.

It is an object of the present invention to provide a wire rope through a tube which has been inserted in a lifting box.

It is an additional object of the present invention to recess the lifting box in concrete or other suitable material in order to provide a lifting apparatus in order to lift the concrete. The lifting box increases the area that the lifting force is distributed against the concrete. Consequently, the lifting apparatus can lift more weight than if a wire rope was used without the lifting box.

It is a further object of the present invention to provide a hollow lifting box so that a cover of the lifting box can be removed to provide a lifting point within the lifting box.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the lifting apparatus of the present invention; and

FIG. 2 illustrates a side view of lifting apparatus of the present invention;

FIG. 3 illustrates an additional side view of the lifting apparatus of the present invention;

FIG. 4 illustrates a perspective view of the lifting apparatus of the present invention;

FIG. 5 illustrates a perspective view of the lifting apparatus of the present invention attached to wire mesh;

FIG. 6 illustrates a side view of the lifting apparatus of the present invention attached to the wire mesh.

### DETAILED DESCRIPTION

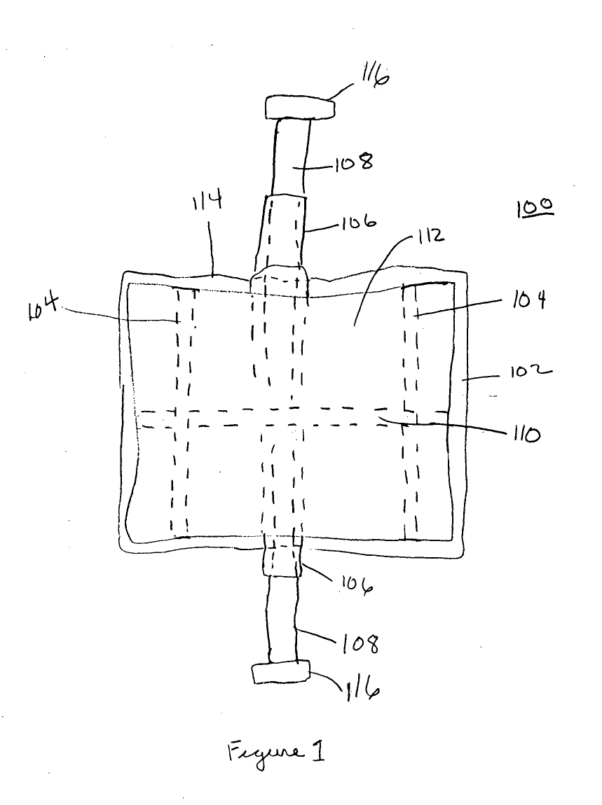

FIG. 1 illustrates the lifting apparatus 100 of the present invention. The lifting apparatus 100 is for use in concrete and other pre-cast molding materials. FIG. 1 illustrates an independent wire rope core (I.W.R.C.) which will be referred to as simply as a wire rope 108 and which is shown as being flexible so that the wire rope 108 can be turned and connected to a wire mesh or Rebar. Additionally, the flexibility of the wire rope 108 reduces the potential breakage of the wire rope 108 below the level of the hardened concrete. The wire rope 108 may be formed from galvanized cable to increase the life of the wire rope 108. FIG. 1 additionally shows that the wire rope 108 has been inserted into an opening of a sleeve 106 or saddle which is shown in FIG. 1 as a hollow cylinder to distribute the weight along a portion of the wire rope 108 and to prevent substantially all the weight from being applied at a single point directly on the wire rope 108. The wire rope 108 and the sleeve 106 are positioned through the lifting box 114 shown as a hollow housing at a first and second opening of the lifting box 114. The lifting box 114 includes a bottom channel 104 formed in the bottom of the lifting box 114 for the enhanced adhesion to the concrete.

FIG. 1 shows two bottom channels 104; however, fewer or additional bottom channels 104 are within the scope of the present invention.

FIG. 1 additionally shows a transverse bottom channel 110 formed in the bottom of the lifting box 114 and formed substantially perpendicular to the bottom channel 104 again for the enhancement of the adhesion to the concrete. Additional transverse bottom channels 110 are within the scope of the present invention. The lifting box 114 includes a breakable cover 112, which is positioned on the top surface of the lifting box 114. The breakable cover 112 is formed such that the breakable cover 112 can be broken and removed from the lifting box 114 to provide access to the interior of the lifting box 114 so that the user of the lifting apparatus 100 can have access to the sleeve 106 and the corresponding portion of the wire rope 108 within the sleeve 106. The user of the lifting apparatus 100 can attach a hook or a second wire rope which may be connected to a material lifting apparatus to the sleeve 106 within the lifting box 114 and lift the load which may be concrete. The breakable cover 112 may have a weakened area around the periphery of the breakable cover 112 to aid in removing the breakable cover 112. The top of the lifting box 114 includes a lip 102 formed around the periphery of the breakable cover 112. Attached at each end of the wire rope 108 is a stop 116 which may be compressed onto the end of the wire rope 108 to prevent the wire rope 108 from moving within the concrete.

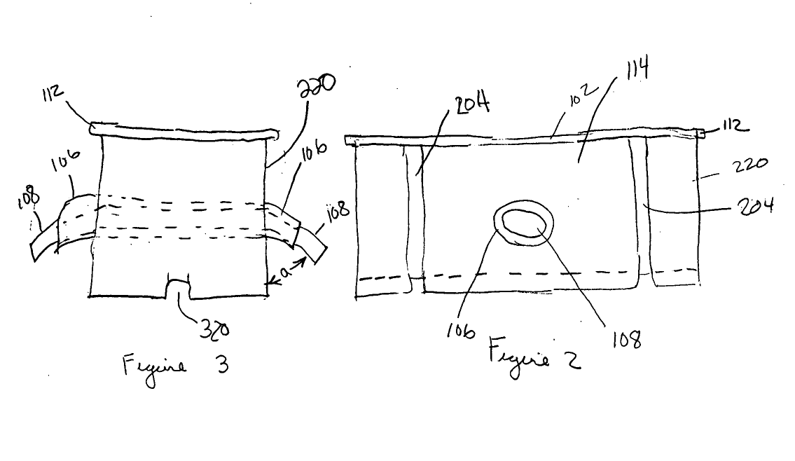

FIG. 2 illustrates a side view of the lifting box 114 which shows a side surface 220 having a opening for the wire rope 108 and the sleeve 106. Additionally, FIG. 2 illustrates vertical channel 204 which extends from the bottom of the lifting box 114 to the lip 102 and which is in communication with the bottom channel 104.

FIG. 3 illustrates another side view of the lifting box 114. FIG. 3 shows the wire rope 108 forming an angle ‘a’ with respect to the side surface 220. The angle ‘a’ may be approximately 30° to allow the wire rope 108 to be attached to the wire mesh or Rebar.

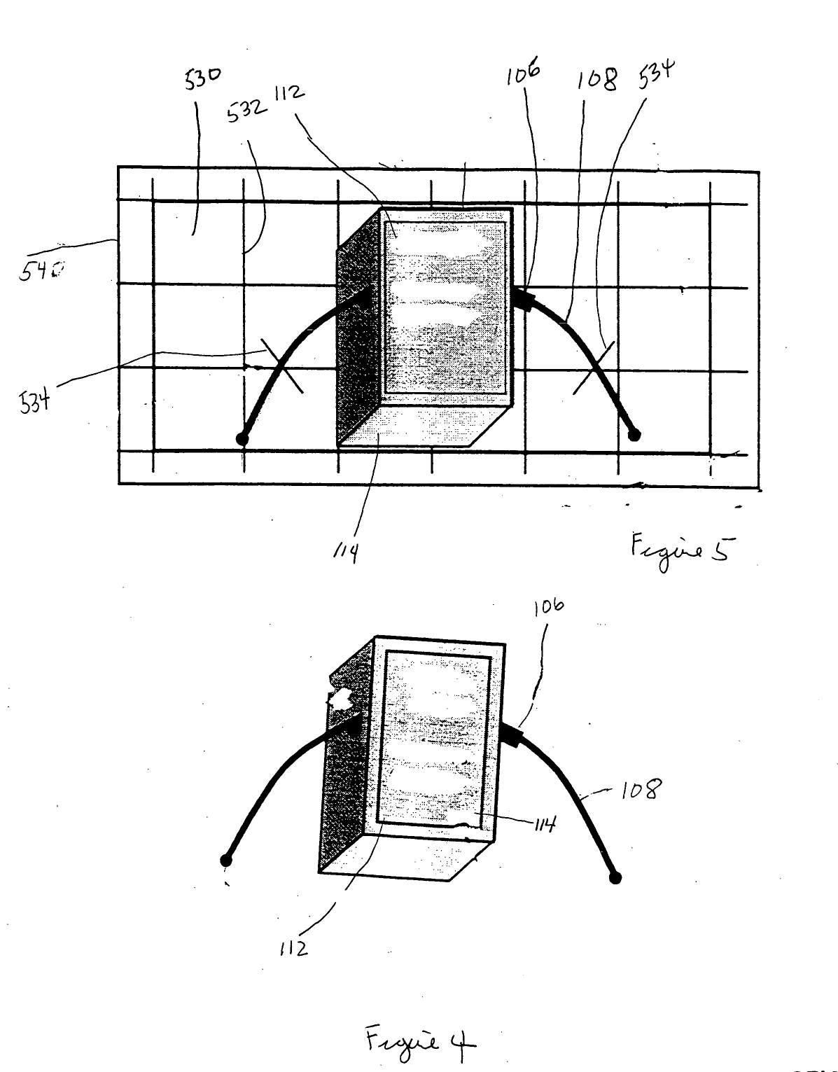

FIG. 4 illustrates a perspective view of the lifting box 114 and the sleeve 106 for the wire rope 108.

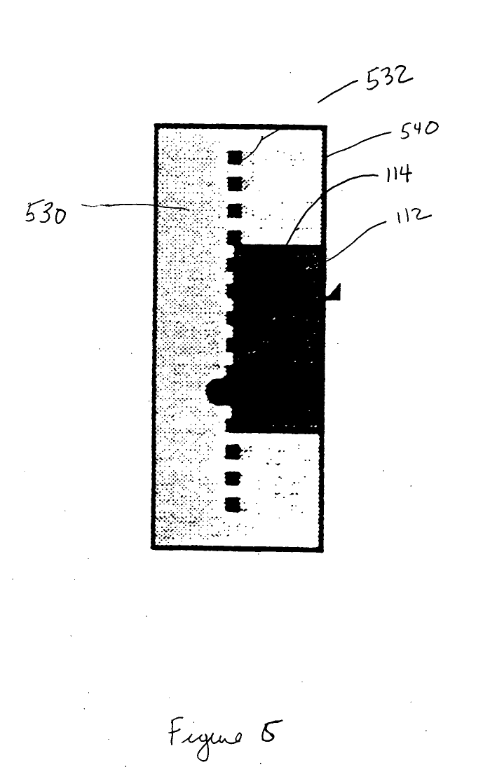

FIG. 5 shows a cross-sectional view of the lifting apparatus 100 which has been placed in concrete 530 or other suitable material in a mold 540. FIG. 5 shows that the wire rope 108 has been placed against a wire mesh 532 or Rebar and secured to the wire mesh 532 by wire ties 534. The number and placement of the wire ties 534 will vary.

FIG. 6 illustrates a side view of the lifting box 114 within the mold 540 which shows the breakable cover 112 positioned adjacent to one side of the mold 540. Concrete 530 or other suitable material is poured into the mold 540 and forms around the lifting box 114 and the wire mesh 532 to form a load such as a wall, round cylinder section, box or pipe or other such object, but the concrete 530 generally is kept away from the breakable cover 112 as a result of being positioned against the side of the mold 540. As a result, as the concrete 530 dries and hardens, the mold 540 is removed allowing the user to have access to the breakable cover 112 of the lifting box 114. The user removes the breakable cover 112 to obtain access to the sleeve 106 within the interior of the lifting box 114. The sleeve 106 receives the hook or another wire rope so that the load can be moved, and the sleeve 106 distributes the weight of the load along a portion of the wire rope 108, avoiding a concentration of weight of the load at a single point on the wire rope 108. The sleeve 106 and a wire rope 108 are free to move with respect to each other, and this freedom of movement prevents undue stress on the wire rope 108 within the concrete.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A lifting apparatus for lifting a load, comprising:
a sleeve for distributing a weight of said load and having a opening;
a flexible wire rope to pass through said opening of said sleeve;
a lifting box having an opening for accepting said sleeve and said flexible wire rope for access to an interior of said lifting box and having a breakable cover to provide access to said sleeve and flexible wire rope.

2) A lifting apparatus for lifting a load as in claim 1, wherein said lifting box includes a bottom channel.

3) A lifting apparatus for lifting a load as in claim 2, wherein said lifting box includes a traverse bottom channel.

4) A lifting apparatus for lifting a load as in claim 1, wherein said lifting box includes a side channel.

5) A lifting apparatus for lifting a load, comprising:
a sleeve for distributing a weight of said load and having a opening;
a flexible wire rope to pass through said opening of said sleeve;
a lifting box having an opening for allowing said sleeve and said flexible wire rope for access to an interior of said lifting box and having a breakable cover to provide access to said sleeve and flexible wire rope;
a wire mesh for connection to said flexible wire rope.

5) A lifting apparatus for lifting a load as in claim 4, wherein said flexible wire rope is connected to said wire mesh by a wire tie.

6) A lifting apparatus for lifting a load as in claim 4, wherein said lifting box includes a channel.

7) A lifting apparatus for lifting a load as in claim 4, wherein a portion of said flexible wire rope and said wire mesh is positioned within a mold.

8) A lifting apparatus for lifting a load as in claim 7, wherein said mold includes concrete.

9) A lifting apparatus for lifting a load as in claim 4, wherein said wire mesh includes Rebar.

10) A lifting apparatus for lifting a load as in claim 6, wherein said lifting box includes a bottom channel.

11) A method for forming a lifting apparatus for lifting a load, comprising the steps of:
distributing a weight of said load on a sleeve having a hollow housing;
passing a flexible wire rope through an opening of said sleeve;
passing said sleeve through a lifting box;
providing access to an interior of said lifting box and said sleeve and said flexible wire rope.

12) A method for forming a lifting apparatus for lifting a load as in claim 18 wherein said flexible wire rope is connected to said wire mesh by a wire tie.

13) A method for forming a lifting apparatus for lifting a load as in claim 11, wherein the method includes the step of forming a channel in said lifting box.

14) A method for forming a lifting apparatus for lifting a load as in claim 11, wherein the method includes the step of forming a bottom channel in a bottom of said lifting box.

15) A method for forming a lifting apparatus for lifting a load as in claim 11, wherein the method includes the step of placing concrete within said mold.

16) A method for forming a lifting apparatus for lifting a load as in claim 11, wherein the method includes the step of connecting Rebar to said wire rope.

17) A method for forming a lifting apparatus for lifting a load as in claim 13, wherein method includes the step of forming a side channel in said lifting box.

18) A method for forming a lifting apparatus for lifting the load as in claim 11, wherein the method includes the step of connecting a wire mesh to said flexible wire rope.
